(19) United States
(12) Patent Application Publication
(10) Pub. No.: US 2006/0238526 A1
(43) Pub. Date: Oct. 26, 2006

(54) DISPLAY APPARATUS, CONTROL METHOD THEREOF AND COMMUNICATION SYSTEM

(76) Inventor: Young-chan KIM, Uiwang-si (KR)

Correspondence Address: STANZIONE & KIM, LLP, 919 18TH STREET, N.W., SUITE 440, WASHINGTON, DC, 20006, US

(21) Appl. No.: 11/379,307

(22) Filed: Apr. 19, 2006

(30) Foreign Application Priority Data
Apr. 22, 2005 (KR) 2005-0033662

(51) Int. Cl. G09G 5/00

(52) U.S. Cl. 345/204

(57) ABSTRACT

A display apparatus includes a first communication line usable for display data channel/command interface (DDC/CI) communication with a first signal source, and a second communication line usable for the DDC/CI communication with a second signal source, a third communication line to connect the first communication line and the second communication line such that the first signal source and the second signal source perform inter-integrated circuit (I2C) communication with each other, a switch to control a connection of the third communication line, and a controller to turn the switch on if the controller determines that the first signal source and the second signal source are ready to perform the I2C communication with each other through the third communication line. Thus, the display apparatus and a communication system having the display apparatus use display data channel command interface (DDC/CI) between the display apparatus and a computer to enable a plurality of computers that are connected to the display apparatus to communicate with one another by sending and/or receiving data therebetween.

### CROSS-REFERENCE TO RELATED APPLICATIONS

This application claims the benefit of Korean Patent Application No. 2005-0033662, filed on Apr. 22, 2005, in the Korean Intellectual Property Office, the disclosure of which is incorporated herein by reference in its entirety.

### BACKGROUND OF THE INVENTION

1. Field of the Invention

The present general inventive concept relates to a display apparatus, a control method thereof, and a communication system comprising the display apparatus, and more particularly, to a communication system comprising a display apparatus which uses a display data channel command interface (DDC/CI) communication line connected thereto such that a plurality of computers can perform inter-integrated circuit (I2C) communication therebetween.

2. Description of the Related Art

Generally, a display apparatus such as a conventional monitor, etc., is provided with a video port which is connected with a computer to receive a video signal.

The conventional monitor has a single video port so that a single computer can be connected thereto. However, a monitor that has been recently developed has two or more video ports so that two or more computers can be connected thereto.

A communication line is typically provided in a DVI or D-SBU port, which are used as the video port to support a display data channel (DDC) so that extended display identification data (EDID) information may be transmitted from the display apparatus to the computers. Further, the monitor may communicate with each of the computers by using display data channel command interface (DDC/CI) protocol according to inter-integrated circuit (I2C) protocol.

The computers may be connected with each other through extra communication lines, such as LAN cables, serial cables, USB cables, etc. to communicate, send, and/or receive data therebetween.

It would be desirable that the communication line between each of the computers and the display apparatus may also be used for communication between the computers, thereby avoiding the need for the extra communication lines between the computers.

### SUMMARY OF THE INVENTION

Accordingly, the present general inventive concept provides a display apparatus, a control method thereof, and a communication system which uses display data channel command interface (DDC/CI) between the display apparatus (e.g., a monitor) and a computer to enable a plurality of computers to be connected to the display apparatus to communicate by sending and/or receiving data therebetween.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a display apparatus, comprising a first communication line to provide display data channel/command interface (DDC/CI) communication with a first signal source, and a second communication line to provide the DDC/CI communication with a second signal source, a third communication line to connect the first communication line and the second communication line such that the first signal source and the second signal source perform inter-integrated circuit (I2C) communication with each other, a switch to control a connection of the third communication line, and a controller to turn the switch on if the controller determines that the first signal source and the second signal source are ready to perform the I2C communication with each other through the third communication line.

The controller may turn the switch off if the controller determines that the I2C communication between the first signal source and the second signal source is completed.

The controller may comprise a memory to store slave setting data to set the second signal source in a slave mode of an I2C protocol and to store slave patch data to indicate that the second signal source is set in the slave mode, and a microcomputer to recognize that the first signal source and the second signal source are ready perform the I2C communication through the third communication line and to turn the switch on if the microcomputer detects that the slave setting data is transmitted to the second signal source and the slave patch data is transmitted to the first signal source.

The microcomputer may store the slave setting data in the memory according to a first control signal received from the first signal source to transmit the slave setting data to the second signal source upon a request received from the second signal source, and may store the slave patch data in the memory according to a transmission of the slave setting data to transmit the slave patch data to the first signal source upon a request received from the first signal source.

The slave setting data may comprise an address to control the second signal source to operate in the slave mode.

The display apparatus may further comprise at least one D-SUB port and/or at least one DVI port, wherein the first communication line and the second communication line are connected to the at least one D-SUB port and/or the at least one DVI port.

The foregoing and/or other aspects of the present general inventive concept are also achieved by providing a display apparatus, comprising a display unit to display one or more images, a first communication interface to communicate with a first external signal source, a second communication interface to communicate with a second external signal source, and a controller to enable a communication session between the first external signal source and the second external signal source via the display apparatus and to manage said communication session.

The foregoing and/or other aspects of the present general inventive concept are also achieved by providing a control method of a display apparatus having a first communication line to provide display data channel/command interface (DDC/CI) communication with a first signal source and a second communication line to provide the DDC/CI communication with a second signal source, the method comprising providing a third communication line to connect the first communication line and the second communication line such that the first signal source and the second signal source perform inter-integrated circuit (I2C) communication, determining whether the first signal source and the second signal source are ready for the I2C communication through the third communication line, and controlling a connection between the first signal source and the second signal source through the third communication line depending on whether the first and second signal sources are determined to be ready for the I2C communication.

The determining of whether the first signal source and the second signal source are ready for the I2C communication may comprise receiving a first control signal from the first signal source, storing slave setting data that correspond to the first control signal in a memory, transmitting the slave setting data to the second signal source upon a request received from the second signal source, changing the second signal source into a slave mode of an I2C protocol according to transmission of the slave setting data to the second signal source, storing slave patch data to indicate that the slave setting data is transmitted to the second signal source, in the memory, transmitting the slave patch data to the first signal source upon a request received from the first signal source, and determining that the first signal source and the second signal source are ready for the I2C communication through the third communication line if the slave patch data is transmitted to the first signal source.

The foregoing and/or other aspects of the present general inventive concept are also achieved by providing a method of controlling a display apparatus having a display unit to display one or more images received through a respective communication interface from a respective external signal source, the method comprising establishing a communication session between a first external signal source and a second external signal source via the display apparatus, and managing the communication session.

The foregoing and/or other aspects of the present general inventive concept are also achieved by providing a connection/communication management device usable with a display apparatus, the device comprising a controller to enable master slave communication between a first computer and the display apparatus in a first mode, and to enable master slave communication between the first computer and a second computer in a second mode through a communication channel within the display apparatus.

The foregoing and/or other aspects of the present general inventive concept are also achieved by providing a communication system, comprising a first signal source, a second signal source, and a display apparatus. The display apparatus displays one or more images and comprises a first communication interface to communicate with a first external signal source, a second communication interface to communicate with a second external signal source, and a controller to enable to establish a communication session between the first external signal source and the second external signal source via the display apparatus and to manage said communication session.

The foregoing and/or other aspects of the present general inventive concept are also achieved by providing a communication network, the network comprising a plurality of external signal sources, and a display apparatus in communication with each of the plurality of external signal sources to display image data received from the plurality of external signal sources and to enable communication between the plurality of external signal sources, wherein the plurality of external signal sources are not connected to each other outside of the display apparatus.

The foregoing and/or other aspects of the present general inventive concept are also achieved by providing a communication system, comprising a first signal source, a second signal source, and a display apparatus. The display apparatus comprises a first communication line to perform display data channel/command interface (DDC/CI) communication with the first signal source, a second communication line to perform the DDC/CI communication with the second signal source, a third communication line to connect the first communication line and the second communication line such that the first signal source and the second signal source perform the I2C communication, a switch to control connection of the third communication line, and a controller to turn the switch on if the controller determines that the first signal source and the second signal source are ready for the I2C communication through the third communication line.

If slave setting data to set the second signal source in a slave mode of an I2C protocol is transmitted to the second signal source and a slave patch data indicating that the second signal source is set in the slave mode is transmitted to the first signal source, the controller may determine that the first signal source and the second signal source are ready for the I2C communication through the third communication line and may turn the switch on.

The controller may store the slave setting data in a memory according to a first control signal received from the first signal source to transmit the slave setting data to the second signal source upon a request received from the second signal source, and may store the slave patch data in the memory based on transmission of the slave setting data to transmit the slave patch data to the first signal source upon a request received from the first signal source.

The slave setting data may comprise an address to control the second signal source to operate in the slave mode of the I2C protocol.

The display apparatus may further comprise at least one D-SUB port and/or at least one DVI port, and the first communication line and the second communication line may be connected to the at least one D-SUB port and/or the at least one DVI port.

The foregoing and/or other aspects of the present general inventive concept are also achieved by providing a computer readable medium containing executable code to control a display apparatus having a first communication line to provide display data channel/command interface (DDC/CI) communication with a first signal source and a second communication line to provide the DDC/CI communication with a second signal source, the medium comprising a first executable code to enable a third communication line to connect the first communication line and the second communication line such that the first signal source and the second signal source perform inter-integrated circuit (I2C) communication, a second executable code to determine whether the first signal source and the second signal source are ready for the I2C communication through the third communication line, and a third executable code to control a connection between the first signal source and the second signal source through the third communication line depending on whether the first signal source and the second signal source are ready for the I2C communication.

### BRIEF DESCRIPTION OF THE DRAWINGS

The above and/or other aspects of the present general inventive concept will become apparent and more readily appreciated from the following description of the embodiments, taken in conjunction with the accompanying drawings of which:

FIG. 1 illustrates a communication system according to an embodiment of the present general inventive concept;

FIG. 2 is a control block diagram illustrating a display apparatus of the communication system of FIG. 1;

FIG. 3 is a control flowchart illustrating an operation of a first signal source of the communication system of FIG. 1;

FIG. 4 is a control flowchart illustrating an operation of a second signal source of the communication system of FIG. 1; and

FIG. 5 is a control flowchart illustrating an operation of the display apparatus of the communication system of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

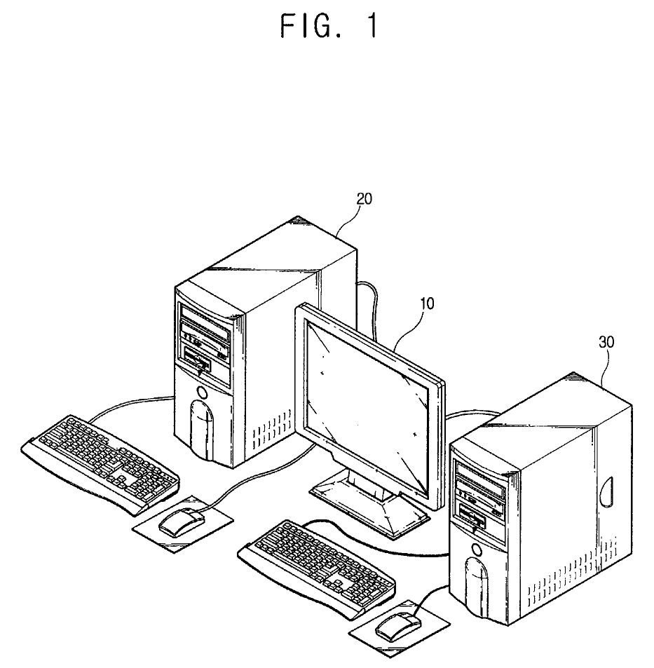

FIG. 1 illustrates a communication system according to an embodiment of the present general inventive concept. As illustrated in FIG. 1, the communication system comprises a first signal source 20, a second signal source 30, and a display apparatus 10.

Here, the first signal source 20 and the second signal source 30 may comprise a computer, a set-top box, or other electronic devices to send and/or receive a predetermined signal to/from the display apparatus 10. For illustration purposes, in the description that follows, the first signal source 20 and the second signal source 30 are described as being a first computer 20 and a second computer 30, respectively. However, this description of the first signal source 20 and the second signal source 30 is not intended to limit the scope of the present general inventive concept.

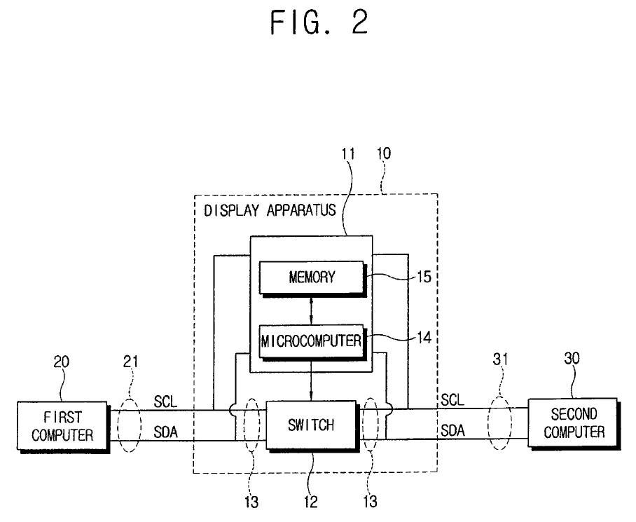

FIG. 2 is a control block diagram illustrating the display apparatus 10 of the communication system of FIG. 1. As illustrated in FIG. 2, the display apparatus 10 comprises a third communication line 13 to connect a first communication line 21 and a second communication line 31, a switch 12 to control a connection of the third communication line 13, and a controller 11 to turn the switch 12 on or off. The controller 11 may comprise a connection/communication management device.

Here, the first communication line 21 is connected with the first computer 20 to enable display data channel command interface (DDC/CI) communication with the first computer 20, and the second communication line 31 is connected with the second computer 30 to enable the DDC/CI communication with the second computer 30.

The first communication line 21 and the second communication line 31 may be connected to a D-SUB port (not shown) or a DVI port (not shown) which are provided on the display apparatus 10.

The controller 11 performs the DDC/CI communication with the first computer 20 and the second computer 30, respectively, through the first communication line 21 and the second communication line 31. The first communication line 21 and the second communication line 31 comprise a serial clock (SCL) line to send and receive a clock signal, and a serial data (SDA) line to send and receive data.

If the first communication line 21 and the second communication line 31 are connected by the third communication line 13, the first computer 20 and the second computer 30 may perform I2C communication with each other through this connection.

If the controller 11 determines that the first computer 20 and the second computer 30 may perform the I2C communication through the third communication line 13, the controller 11 turns the switch 12 on. If the controller 11 determines that the I2C communication is completed between the first computer 20 and the second computer 30, the controller 11 turns the switch 12 off.

Here, the controller 11 may comprise a memory 15 and a microcomputer 14 to turn the switch 12 on and off.

The memory 15 stores slave setting data to set the second computer 30 in a slave mode of an I2C protocol for the I2C communication, and slave patch data to indicate that the second computer 30 is set in the slave mode. The slave setting data may include instructions for the second computer 30 to operate in the slave mode, and the slave patch data may include instructions to transmit transmission data to the second computer 30 in the slave mode.

The microcomputer 14 stores the slave setting data in the memory 15 according to a first control signal of the first computer 20, which sets the second computer 30 in the slave mode of the I2C protocol, and transmits the slave setting data to the second computer 30 upon a request from the second computer 30. Also, the microcomputer 14 stores the slave patch data in the memory 15 to indicate that the slave setting data is transmitted (i.e., has already been transmitted) to the second computer 30, and transmits the slave patch data to the first computer 20 upon a request from the first computer 20. The receiving of the slave setting data from the first computer 20 may act as a request to communicate with the second computer 30 using the I2C protocol.

Hereinbelow, a process of determining whether conditions for turning the switch 12 on are satisfied will be described. Here, the first computer 20 and the second computer 30 will be described as a master and a slave of the I2C protocol, respectively, by way of example. However, it should be understood that the second computer 30 may instead be designated as the master and the first computer 20 may be designated as the slave of the I2C protocol.

First, the first computer 20 and the second computer 30 both operate as the master with respect to the display apparatus 10. The first computer 20 then transmits the first control signal to the display apparatus 10 to operate the second computer 30 in the slave mode of the I2C protocol for the I2C communication with the second computer 30. The first control signal may include the slave setting data, and may be a communication initialization signal.

Then, the microcomputer 14 of the display apparatus 10 stores the slave setting data in the memory 15 to operate the second computer 30 in the slave mode of the I2C protocol based on the first control signal received from the first computer 20.

The second computer 30 reads the slave setting data stored in the memory 15 of the display apparatus 10 while requesting data from the display apparatus 10, periodically. Accordingly, the second computer 30 is set in the slave mode of the I2C protocol for the I2C communication with the first computer 20.

The slave setting data may comprise an address to set the second computer 30 in the slave mode. The second computer 30 changes an address for the I2C communication into an address to operate in the slave mode.

If the slave setting data is transmitted to the second computer 30, the slave patch data is stored in the memory 15 to indicate transmission of the slave setting data to the second computer 30. In other words, once the second computer 30 receives the slave setting data, the slave patch data is transmitted from the second computer 30 to the controller 11 and is stored in the memory 15.

The slave patch data may be stored in the memory 15 according to the second control signal of the second computer 30 receiving the slave setting data, or may be stored in the memory 15 when the microcomputer 14 detects the transmission of the slave setting data. The slave patch data may be included in the second control signal transmitted by the second computer 30.

If the first computer 20 reads the slave patch data, the microcomputer 14 applies an “on” signal to the switch 12 to connect the third communication line 13 such that the first computer 20 and the second computer 30 perform the I2C communication through the third communication line 13.

The microcomputer 14 may alternatively apply the “on” signal to the switch 12 after the second computer 30 reads the slave setting data.

If the first computer 20 receives the slave patch data while requesting data from the display apparatus 10 periodically, the first computer 20 determines that the second computer 30 is changed into the slave mode for the I2C communication, and transmits the transmission data for the I2C communication to the second computer 30. Thus, the first computer 20 can transmit the transmission data to the second computer 30 during the I2C communication.

Here, synchronization information for the communication including, for example, a transmission speed acceptable by the second computer 30, may be included in the slave patch data, or may be modified after a basic connection for the I2C communication between the first computer 20 and the second computer 30 is established.

If the controller 11 receives a completion command from the first computer 20 that the I2C communication between the first computer 20 and the second computer 30 is completed, the microcomputer 14 determines that conditions are satisfied to turn the switch 12 off. Even if the completion command is not received from the first computer 20, the microcomputer 14 may detect the communication between the first computer 20 and the second computer 30 (i.e., whether the communication is still in progress), and the microcomputer 14 may turn the switch 12 off after the I2C communication between the first computer 20 and the second computer 30 is completed.

The memory 15 may be provided on an outside of the microcomputer 14, by way of example. Alternatively, the memory 15 may be provided inside of the microcomputer 14 and may be, for example, a register.

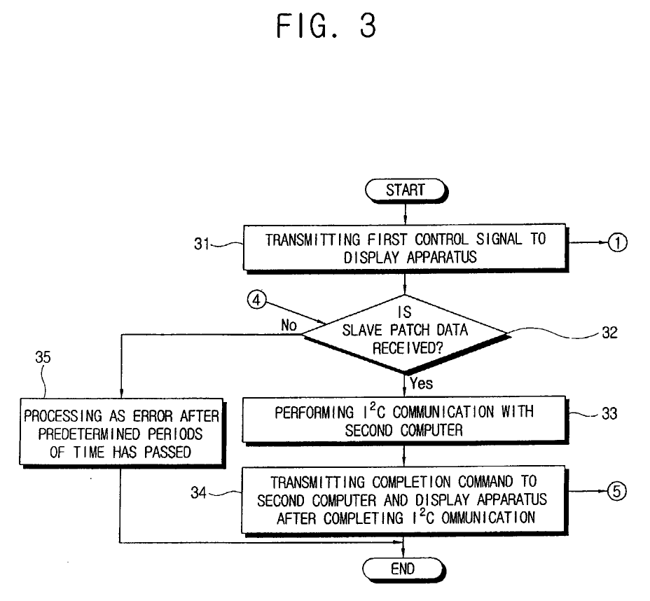

FIGS. 3 through 5 are control flowcharts illustrating operations of the first computer 20, the second computer 30, and the display apparatus 10 of the communication system, respectively, according to embodiments of the present general inventive concept.

Referring to FIG. 3, the first computer 20 transmits an initiation command to set the second computer 30 in the slave mode of the I2C protocol and transmits the first control signal comprising a slave address to be used when the second computer 30 operates in the slave mode to the display apparatus 10 at operation 31.

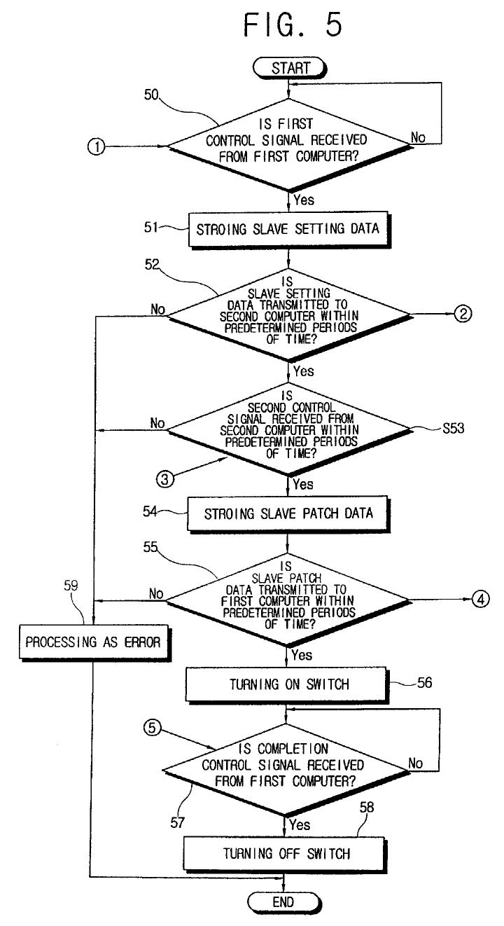

Referring to FIG. 5, if the first control signal is received by the display apparatus 10 at operation S50, the microcomputer 14 of the display apparatus 10 stores the slave setting data in the memory 15 based on the first control signal at operation 51.

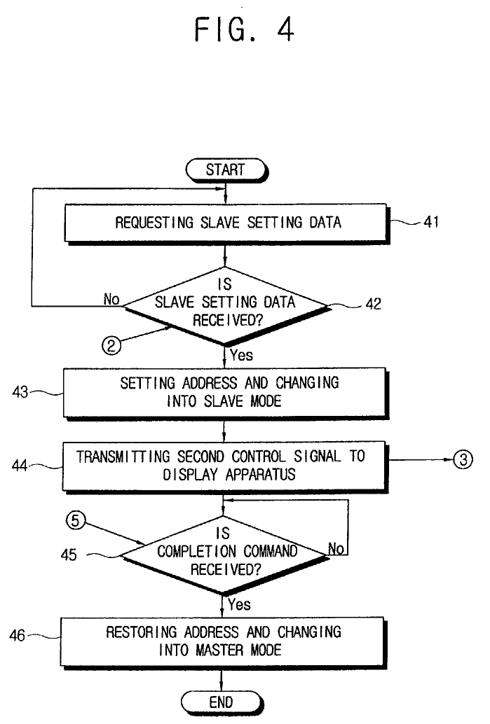

Referring to FIG. 4, meanwhile the second computer 30 requests the slave setting data from the display apparatus 10 at operation 41. If the slave setting data is received from the display apparatus 10 at the second computer 30 at operation 42, the second computer 30 is changed into the slave mode of the I2C protocol for the I2C communication with the first computer 20, and sets an address at operation 43. Also, the second computer 30 transmits the second control signal indicating the receipt of the slave setting data to the display apparatus at operation 44.

Referring to FIG. 5, at this time, if the second control signal is received at the display apparatus 10 within predetermined periods of time from the second computer 30 at operation 53, the microcomputer 14 stores the slave patch data in the memory 15 based on the second control signal at operation 54.

Referring back to FIG. 3, meanwhile the first computer 20 periodically requests the slave patch data from the display apparatus 10, and determines whether the second computer 30 has read the slave setting data at operation 32. If the slave patch data is received from the display apparatus 10 by the first computer 20 and it is determined that the second computer 30 has read the slave setting data, the first computer 20 transmits the transmission data to the second computer 30 for the I2C communication at operation 33.

Referring to FIG. 5, if the slave patch data is transmitted to the first computer 20 within the predetermined periods of time at operation 55, the microcomputer 14 determines that the first computer 20 and the second computer 30 are ready to perform the I2C communication and turns the switch 12 on to connect the third communication line 13 for the I2C communication between the first computer 20 and the second computer 30 at operation 56.

Meanwhile, referring back to FIG. 3, the first computer 20 transmits the completion command to the display apparatus 10 and the second computer 30 when the I2C communication with the second computer 30 is completed, at operation 34.

Referring to FIG. 4, if the completion command is received by the display apparatus 10 at operation 45, the second computer 30 is changed back into the master mode of the I2C protocol with respect to the display apparatus 10 and restores an initial address at operation 46.

Referring to FIG. 5, the microcomputer 14 then cuts off the connection of the third communication line 13 by turning the switch 12 off if the completion command is received by the display apparatus at operation 57.

Then, the first computer 20 and the second computer 30 both operate as the master with respect to the display apparatus 10, and one computer transmits the first control signal to the display apparatus 10 for the I2C communication with other computers, as necessary. Thus, either the first computer 20 or the second computer 30 can transmit the initiation command (i.e., the first control signal) to initiate the I2C communication therebetween.

Referring to FIGS. 3 and 5, the first computer 20 and the display apparatus 10 perform an error-related process at operations 35 and 59 if the slave patch data is not received by the first computer 20 or if predetermined data operations are not performed within predetermined periods of time. The first computer 20 and the display apparatus 10 may notify a user of any errors. For example, the display apparatus 10 may output error messages on a screen thereof or may flicker an OSD.

The embodiments of the present general inventive concept can be embodied as computer readable codes on a computer readable recording medium. The computer readable recording medium may include any data storage device that can store data which can be thereafter read by a computer system. Examples of the computer readable recording medium include a read-only memory (ROM), a random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The embodiments of the present general inventive concept may also be embodied in hardware or a combination of hardware and software. For example, the control method of the communication system and/or the display apparatus may be embodied in software.

Additionally, the first and second computers 20 and 30 may communicate with the display apparatus wirelessly or through a wire. In this case, the display apparatus may have a first communication interface to communication with the first computer 20 and a second communication interface to communicate with the second computer 30.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A display apparatus, comprising:
a first communication line to provide display data channel/command interface (DDC/CI) communication with a first signal source;
a second communication line to provide the DDC/CI communication with a second signal source;
a third communication line to connect the first communication line and the second communication line such that the first signal source and the second signal source perform inter-integrated circuit (I2C) communication with each other;
a switch to control a connection of the third communication line; and
a controller to turn the switch on if the controller determines that the first signal source and the second signal source are ready to perform the I2C communication with each other through the third communication line.

2. The display apparatus according to claim 1, wherein the controller turns the switch off if the controller determines that the I2C communication between the first signal source and the second signal source is completed.

3. The display apparatus according to claim 1, wherein the controller comprises:
a memory to store slave setting data to set the second signal source in a slave mode of an I2C protocol and to store slave patch data to indicate that the second signal source is set in the slave mode; and
a microcomputer to recognize that the first signal source and the second signal source are ready to perform the I2C communication through the third communication line and to turn the switch on if the microcomputer determines that the slave setting data is transmitted to the second signal source and the slave patch data is transmitted to the first signal source.

4. The display apparatus according to claim 3, wherein the microcomputer stores the slave setting data in the memory according to a first control signal received from the first signal source to transmit the slave setting data to the second signal source upon a request received from the second signal source, and stores the slave patch data in the memory according to a transmission of the slave setting data from the second signal source to transmit the slave patch data to the first signal source upon a request from the first signal source.

5. The display apparatus according to claim 4, wherein the slave setting data comprises an address to control the second signal source to operate in the slave mode.

6. The display apparatus according to claim 3, wherein the slave setting data comprises an address to control the second signal source to operate in the slave mode.

7. The display apparatus according to claim 1, further comprising:
at least one D-SUB port and/or at least one DVI port, wherein the first communication line and the second communication line are connected to the at least one D-SUB port and/or the at least one DVI port.

8. A control method of a display apparatus having a first communication line to provide display data channel/command interface (DDC/CI) communication with a first signal source and a second communication line to provide the DDC/CI communication with a second signal source, the method comprising:
providing a third communication line to connect the first communication line and the second communication line such that the first signal source and the second signal source perform inter-integrated circuit (I2C) communication;
determining whether the first signal source and the second signal source are ready for the I2C communication through the third communication line; and
controlling a connection between the first signal source and the second signal source through the third communication line depending on whether the first signal source and the second signal source are ready for the I2C communication.

9. The control method according to claim 8, wherein the determining of whether the first signal source and the second signal source are ready for the I2C communication comprises:
receiving a first control signal from the first signal source;
storing slave setting data that corresponds to the first control signal in a memory;
transmitting the slave setting data to the second signal source upon a request received from the second signal source;
changing the second signal source into a slave mode of an I2C protocol according to a transmission of the slave setting data to the second signal source;
storing a slave patch data to indicate that the slave setting data is transmitted to the second signal source, in the memory;
transmitting the slave patch data to the first signal source upon a request received from the first signal source; and
determining that the first signal source and the second signal source are ready for the I2C communication through the third communication line if the slave patch data is transmitted to the first signal source.

10. A method of controlling a display apparatus having a display unit to display one or more images received through a respective communication interface from a respective external signal source, the method comprising:
establishing a communication session between a first external signal source and a second external signal source via the display apparatus; and
managing the communication session.

11. The method of claim 10, wherein the first and second communication interfaces comprise first and second ports, and the establishing of the communication session comprises:
receiving first and second initialization data from the first and second external signal sources at the respective first and second communication interfaces; and
exchanging the first and second initialization data between the first and second external signal sources to set up a master slave communication session using I2C protocol.

12. A display apparatus, comprising:
a display unit to display one or more images;
a first communication interface to communicate with a first external signal source;
a second communication interface to communicate with a second external signal source; and
a controller to enable to establish a communication session between the first external signal source and the second external signal source via the display apparatus and to manage the communication session.

13. The display apparatus of claim 12, wherein the first and second communication interfaces comprise first and second ports.

14. The display apparatus of claim 12, wherein the display apparatus operates in one of a first mode in which the controller receives data from at least one of the first and second external signal sources via one of the first and second communication interfaces, respectively, and a second mode in which the controller relays data between the first and second communication interfaces such that the communication session is established.

15. The display apparatus of claim 12, further comprising:
a switch to connect the first communication interface with the second communication interface when the communication session is established and to disconnect the second communication interface from the first communication interface when the communication session is not in progress according to one or more control signals from the controller.

16. The display apparatus of claim 12, wherein the communication session comprises a master-slave inter-integrated circuit (I2C) communication using I2C protocol.

17. The display apparatus of claim 12, wherein the controller receives a first control signal including slave setting data from the first external signal source, transmits the slave setting data to the second external signal source, receives slave patch data from the second external signal source, transmits the slave patch data to the first external signal source, and establishes the communication session once the first external signal source receives the slave patch data and the second external signal source receives the slave setting data.

18. The display apparatus of claim 12, wherein the controller exchanges first and second communication initialization signals between the first and second external signal sources, respectively, and establishes the communication session according to the first and second communication initialization signals.

19. The display apparatus of claim 18, wherein the first communication initialization signal includes an address to operate as a slave device in a slave mode, and the second communication initialization signal includes synchronization information to transmit data to the slave device.

20. The display apparatus of claim 12, wherein the first and second external signal sources are one of computers, set-top boxes, personal digital assistants, and electronic devices capable of I2C communication.

21. The display apparatus of claim 12, further comprising:
the first external signal source connected to the first communication interface via a first communication line; and
the second external signal source connected to the second communication interface via a second communication line, wherein the first and second communication lines each include a serial clock line (SCL) and a serial data line (SDL).

22. The display apparatus of claim 12, wherein the controller comprises:
a memory to store slave setting data received from one of the first and second external signal sources as a communication request and to enable the first and second external signal sources to access the memory periodically to determine whether any communication requests have been received by the controller.

23. The display apparatus of claim 12, wherein the controller comprises:
a memory to store a communication request received from the first external signal source for master-slave communication session with the second external signal source and to enable the second external signal source to periodically check whether the controller has received any requests for the master slave communication session with the first external signal source.

24. A connection/communication management device usable with a display apparatus, the device comprising:
a controller to enable master slave communication between a first computer and the display apparatus in a first mode, and to enable master slave communication between the first computer and a second computer in a second mode through a communication channel within the display apparatus.

25. A communication system, comprising:
a first signal source;
a second signal source; and
a display apparatus, comprising
a display unit to display one or more images,
a first communication interface to communicate with a first external signal source,
a second communication interface to communicate with a second external signal source, and
a controller to enable to establish a communication session between the first external signal source and the second external signal source via the display apparatus and to manage said communication session.

26. A communication network, the network comprising:
a plurality of external signal sources; and
an display apparatus in communication with each of the plurality of external signal sources to display image data received from the plurality of external signal sources and to enable communication between the plurality of external signal sources, wherein the plurality of external signal sources are not connected to each other outside of the display apparatus.

27. A communication system, comprising:
a first signal source;
a second signal source; and
a display apparatus, comprising
a first communication line to perform a display data channel/command interface (DDC/CI) communication with the first signal source,
a second communication line to perform the DDC/CI communication with the second signal source,
a third communication line to connect the first communication line and the second communication line such that the first signal source and the second signal source perform the I2C communication,
a switch to control a connection of the third communication line, and
a controller to turn the switch on if the controller determines that the first signal source and the second signal source are ready for the I2C communication through the third communication line.

28. The communication system according to clam 27, wherein if a slave setting data to set the second signal source in a slave mode of an I2C protocol is transmitted to the second signal source, and a slave patch data indicating that the second signal source is set in the slave mode is transmitted to the first signal source, the controller determines that the first signal source and the second signal source are ready for the I2C communication through the third communication line and turns the switch on.

29. The communication system according to claim 28, wherein the controller stores the slave setting data in a memory according to a first control signal received from the first signal source to transmit the slave setting data to the second signal source upon a request received from the second signal source, and stores the slave patch data in the memory based on a transmission of the slave setting data to the second signal source to transmit the slave patch data to the first signal source upon a request received from the first signal source.

30. The communication system according to claim 29, wherein the slave setting data comprises an address to control the second signal source to operate in the slave mode of the I2C protocol.

31. The communication system according to claim 28, wherein the slave setting data comprises an address to control the second signal source to operate in the slave mode of the I2C protocol.

32. The communication system according to claim 27, wherein the display apparatus further comprises:
at least one D-SUB port and/or at least one DVI port, and the first communication line and the second communication line are connected to the at least one D-SUB port and/or the at least one DVI port.

33. A computer readable medium containing executable code to control a display apparatus having a first communication line to provide display data channel/command interface (DDC/CI) communication with a first signal source and a second communication line to provide the DDC/CI communication with a second signal source, the medium comprising:
a first executable code to enable a third communication line to connect the first communication line and the second communication line such that the first signal source and the second signal source perform inter-integrated circuit (I2C) communication;
a second executable code to determine whether the first signal source and the second signal source are ready for the I2C communication through the third communication line; and
a third executable code to control a connection between the first signal source and the second signal source through the third communication line depending on whether the first signal source and the second signal source are ready for the I2C communication.
